(19) United States
(12) Patent Application Publication
(10) Pub. No.: US 2019/0009515 A1
(43) Pub. Date: Jan. 10, 2019

(54) PRINTING APPARATUS AND PRINTING METHOD THEREOF

(71) Applicant: CANON KABUSHIKI KAISHA, Tokyo (JP)

(72) Inventors: Kyosuke Deguchi, Yokohama-shi (JP); Ryosuke Hirokawa, Kawasaki-shi (JP); Makoto Terui, Yokohama-shi (JP); Yoshiyuki Honda, Yokohama-shi (JP)

(21) Appl. No.: 16/015,976

(22) Filed: Jun. 22, 2018

(30) Foreign Application Priority Data
Jul. 4, 2017 (JP) 2017-131492

(51) Int. Cl. B41J 2/005

(52) U.S. Cl. CPC B41J 2/0057

(57) ABSTRACT

In a printing apparatus, an image is formed by an inkjet printhead, and a liquid component is absorbed from the image by bringing a cyclically movable liquid absorbing member into contact with the image. Then, the member is nipped by the first roller that contacts the first surface of the member, and the second roller that has a vertical positional relationship with respect to the first roller and contacts the second surface on a side opposite to the first surface. Furthermore, a region where the member is pressurized is formed by sealing the member by bending and winding the member around the first roller located on an upper side of the second roller at the nipped position. Then, the absorbed liquid component is pushed out and collected by moving the member in the nipped state.

### BACKGROUND OF THE INVENTION

### Field of the Invention

The present invention relates to a printing apparatus and a printing method thereof, and particularly to, for example, a technique of absorbing a liquid component of ink discharged to a transfer member from a printhead in a printing apparatus that transfers an image formed by discharging the ink to the transfer member and prints the image.

### Description of the Related Art

In an inkjet printing method, an image is formed by applying a liquid composition (ink) including a coloring material onto a print medium such as paper directly or indirectly. At this time, curling or cockling may occur when the print medium absorbs a liquid component in the ink excessively.

In order to remove the liquid component in the ink quickly, there is a method of drying a print medium by warm air, infrared rays or the like, or a method of forming an image on a transfer member, then drying a liquid component included in the image on the transfer member by thermal energy or the like, and then transferring the image on a print medium such as paper.

Furthermore, as a means for removing the liquid component included in the image on the transfer member, a method of absorbing and removing a liquid component from an ink image by bringing a roller-like porous body into contact with an ink image without using thermal energy has been proposed (see Japanese Patent Laid-Open No. 2009-045851).

As a means for collecting the absorbed liquid component, a method of pushing out and collecting a liquid by pressing it with a counter roller has been disclosed (see Japanese Patent Laid-Open No. 2001-179959).

However, for example, if the liquid is pushed out and collected by pressing it with the counter roller as disclosed in Japanese Patent Laid-Open No. 2001-179959, the liquid is pushed out of both surfaces of a liquid collecting member. It is preferable that a thickening prevention liquid is applied to the first surface of a liquid absorbing member after the liquid component included in the image is absorbed from the first surface. However, the liquid supplied to prevent thickening is also pushed out of the first surface at the time of liquid collection.

### SUMMARY OF THE INVENTION

Accordingly, the present invention is conceived as a response to the above-described disadvantages of the conventional art.

For example, a printing apparatus and a printing method thereof according to this invention are capable of removing a liquid stably from a liquid absorbing member that absorbs a liquid component from a formed image, keeping absorption performance of the liquid absorbing member satisfactorily, and implementing higher-quality image formation and image printing.

According to one aspect of the present invention, there is provided a printing apparatus comprising: a transfer member configured to be moved cyclically; a print unit configured to form an image on the transfer member by discharging ink to the transfer member; a transfer unit configured to perform a transfer operation of transferring, to a print medium, the image formed on the transfer member; and a liquid absorbing unit configured to absorb a liquid component from the image on the transfer member before the transfer operation, wherein the liquid absorbing unit comprises: an endless liquid absorbing member having a first surface that contacts the transfer member and a second surface on a side opposite to the first surface; a moving unit configured to cyclically rotate and move the liquid absorbing member; a first roller that contacts the first surface; a second roller that contacts the second surface and nips the liquid absorbing member with the first roller; and a collection unit configured to push out and collect a liquid component absorbed by the liquid absorbing member by bending and winding the liquid absorbing member around the first roller located on an upper side of the second roller at the nipped position, and moving the liquid absorbing member with the moving unit while holding the nipped state.

According to another aspect of the present invention, there is provided a printing method comprising: forming an image by discharging ink from a printhead; absorbing a liquid component from the image by bringing a cyclically movable liquid absorbing member into contact with the image; nipping the liquid absorbing member by a first roller that contacts a first surface of the liquid absorbing member and a second roller that has a vertical positional relationship with respect to the first roller and contacts a second surface on a side opposite to the first surface; forming a region in which the liquid absorbing member is pressurized by sealing the liquid absorbing member by bending and winding the liquid absorbing member around the first roller located on an upper side of the second roller at the nipped position; and pushing out and collecting a liquid component absorbed by the liquid absorbing member by moving the liquid absorbing member while holding the nipped state.

The invention is particularly advantageous since it is possible to remove a liquid stably from a liquid absorbing member that absorbs a liquid component from a formed image.

Further features of the present invention will become apparent from the following description of exemplary embodiments (with reference to the attached drawings).

### BRIEF DESCRIPTION OF THE DRAWINGS

FIG. 1 is a schematic view showing a printing system according to an exemplary embodiment of the present invention;

FIG. 2 is a perspective view showing a print unit;

FIG. 3 is an explanatory view showing a displacement mode of the print unit in FIG. 2;

FIG. 4 is a block diagram showing a control system of the printing system in FIG. 1;

FIG. 5 is a block diagram showing the control system of the printing system in FIG. 1;

FIG. 6 is an explanatory view showing an example of the operation of the printing system in FIG. 1;

FIG. 7 is an explanatory view showing an example of the operation of the printing system in FIG. 1;

FIG. 8 is a schematic view showing the general construction of the absorption unit;

FIGS. 9A and 9B are explanatory views explaining the operation of the displacing unit;

FIG. 10 is a schematic view showing the arrangement of the collection unit 54;

FIG. 11 is a schematic view showing the arrangement of the collection unit 54;

FIG. 12 is a schematic view showing the arrangement of the collection unit 54;

FIG. 13 is a schematic view showing the arrangement of the collection unit 54; and

FIG. 14 is a side view showing the arrangement of the printing apparatus that adopts the method of printing the image by discharging the ink from the printhead directly to the print medium.

### DESCRIPTION OF THE EMBODIMENTS

Exemplary embodiments of the present invention will now be described in detail in accordance with the accompanying drawings. Note that in each drawing, arrows X and Y indicate horizontal directions perpendicular to each other, and an arrow Z indicates a up/down direction.

### Description of Terms

In this specification, the terms “print” and “printing” not only include the formation of significant information such as characters and graphics, but also broadly includes the formation of images, figures, patterns, and the like on a print medium, or the processing of the medium, regardless of whether they are significant or insignificant and whether they are so visualized as to be visually perceivable by humans.

Also, the term “print medium (or sheet)” not only includes a paper sheet used in common printing apparatuses, but also broadly includes materials, such as cloth, a plastic film, a metal plate, glass, ceramics, wood, and leather, capable of accepting ink.

Furthermore, the term “ink” (to be also referred to as a “liquid” hereinafter) should be broadly interpreted to be similar to the definition of “print” described above. That is, “ink” includes a liquid which, when applied onto a print medium, can form images, figures, patterns, and the like, can process the print medium, and can process ink. The process of ink includes, for example, solidifying or insolubilizing a coloring agent contained in ink applied to the print medium. Note that this invention is not limited to any specific ink component, however, it is assumed that this embodiment uses water-base ink including water, resin, and pigment serving as coloring material.

Further, a “print element (or nozzle)” generically means an ink orifice or a liquid channel communicating with it, and an element for generating energy used to discharge ink, unless otherwise specified.

An element substrate for a printhead (head substrate) used below means not merely a base made of a silicon semiconductor, but an arrangement in which elements, wirings, and the like are arranged.

Further, “on the substrate” means not merely “on an element substrate”, but even “the surface of the element substrate” and “inside the element substrate near the surface”. In the present invention, “built-in” means not merely arranging respective elements as separate members on the base surface, but integrally forming and manufacturing respective elements on an element substrate by a semiconductor circuit manufacturing process or the like.

<Printing System>

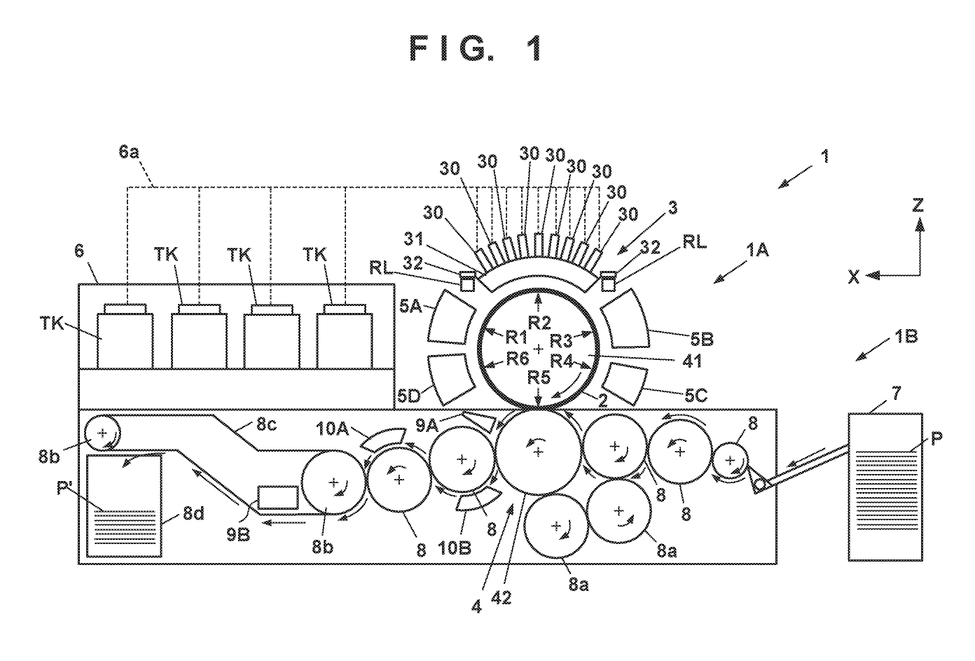

FIG. 1 is a front view schematically showing a printing system 1 according to an embodiment of the present invention. The printing system 1 is a sheet inkjet printer that forms a printed product P′ by transferring an ink image to a print medium P via a transfer member 2. The printing system 1 includes a printing apparatus 1A and a conveyance apparatus 1B. In this embodiment, an X direction, a Y direction, and a Z direction indicate the widthwise direction (total length direction), the depth direction, and the height direction of the printing system 1, respectively. The print medium P is conveyed in the X direction.

This invention is not limited to any specific ink component, however, it is assumed that this embodiment uses water-base ink including water, resin, and pigment serving as coloring material.

<Printing Apparatus>

The printing apparatus 1A includes a print unit 3, a transfer unit 4, peripheral units 5A to 5D, and a supply unit 6.

<Print Unit>

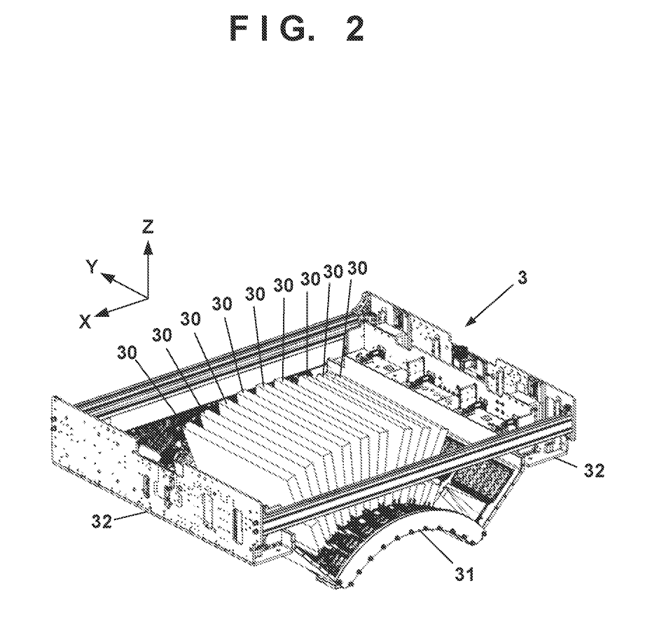

The print unit 3 includes a plurality of printheads 30 and a carriage 31. A description will be made with reference to FIGS. 1 and 2. FIG. 2 is perspective view showing the print unit 3. The printheads 30 discharge liquid ink to the transfer member (intermediate transfer member) 2 and form ink images of a printed image on the transfer member 2.

In this embodiment, each printhead 30 is a full-line head elongated in the Y direction, and nozzles are arrayed in a range where they cover the width of an image printing area of a print medium having a usable maximum size. Each printhead 30 has an ink discharge surface with the opened nozzle on its lower surface, and the ink discharge surface faces the surface of the transfer member 2 via a minute gap (for example, several mm). In this embodiment, the transfer member 2 is configured to move on a circular orbit cyclically, and thus the plurality of printheads 30 are arranged radially.

Each nozzle includes a discharge element. The discharge element is, for example, an element that generates a pressure in the nozzle and discharges ink in the nozzle, and the technique of an inkjet head in a well-known inkjet printer is applicable. For example, an element that discharges ink by causing film boiling in ink with an electrothermal transducer and forming a bubble, an element that discharges ink by an electromechanical transducer (piezoelectric element), an element that discharges ink by using static electricity, or the like can be given as the discharge element. A discharge element that uses the electrothermal transducer can be used from the viewpoint of high-speed and high-density printing.

In this embodiment, nine printheads 30 are provided. The respective printheads 30 discharge different kinds of inks. The different kinds of inks are, for example, different in coloring material and include yellow ink, magenta ink, cyan ink, black ink, and the like. One printhead 30 discharges one kind of ink. However, one printhead 30 may be configured to discharge the plurality of kinds of inks. When the plurality of printheads 30 are thus provided, some of them may discharge ink (for example, clear ink) that does not include a coloring material.

The carriage 31 supports the plurality of printheads 30. The end of each printhead 30 on the side of an ink discharge surface is fixed to the carriage 31. This makes it possible to maintain a gap on the surface between the ink discharge surface and the transfer member 2 more precisely. The carriage 31 is configured to be displaceable while mounting the printheads 30 by the guide of each guide member RL. In this embodiment, the guide members RL are rail members elongated in the Y direction and provided as a pair separately in the X direction. A slide portion 32 is provided on each side of the carriage 31 in the X direction. The slide portions 32 engage with the guide members RL and slide along the guide members RL in the Y direction.

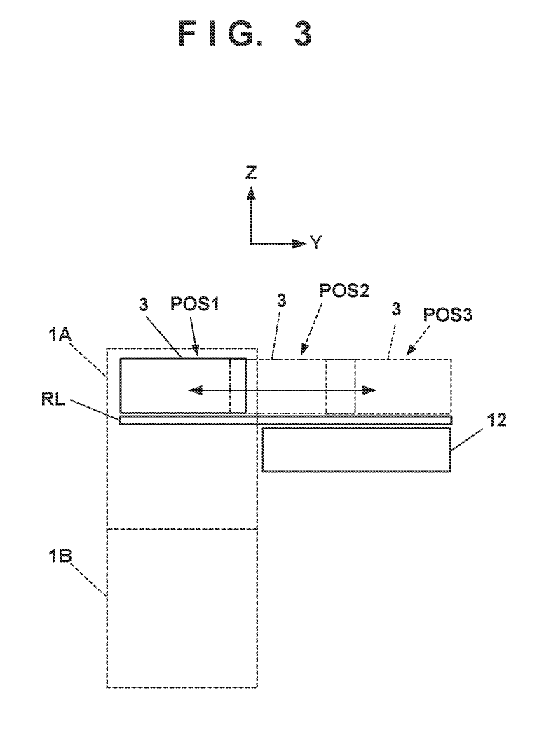

FIG. 3 is a view showing a displacement mode of the print unit 3 and schematically shows the right side surface of the printing system 1. A recovery unit 12 is provided in the rear of the printing system 1. The recovery unit 12 has a mechanism for recovering discharge performance of the printheads 30. For example, a cap mechanism which caps the ink discharge surface of each printhead 30, a wiper mechanism which wipes the ink discharge surface, a suction mechanism which sucks ink in the printhead 30 by a negative pressure from the ink discharge surface can be given as such mechanisms.

The guide member RL is elongated over the recovery unit 12 from the side of the transfer member 2. By the guide of the guide member RL, the print unit 3 is displaceable between a discharge position POS1 at which the print unit 3 is indicated by a solid line and a recovery position POS3 at which the print unit 3 is indicated by a broken line, and is moved by a driving mechanism (not shown).

The discharge position POS1 is a position at which the print unit 3 discharges ink to the transfer member 2 and a position at which the ink discharge surface of each printhead 30 faces the surface of the transfer member 2. The recovery position POS3 is a position retracted from the discharge position POS1 and a position at which the print unit 3 is positioned above the recovery unit 12. The recovery unit 12 can perform recovery processing on the printheads 30 when the print unit 3 is positioned at the recovery position POS3. In this embodiment, the recovery unit 12 can also perform the recovery processing in the middle of movement before the print unit 3 reaches the recovery position POS3. There is a preliminary recovery position POS2 between the discharge position POS1 and the recovery position POS3. The recovery unit 12 can perform preliminary recovery processing on the printheads 30 at the preliminary recovery position POS2 while the printheads 30 move from the discharge position POS1 to the recovery position POS3.

<Transfer Unit>

The transfer unit 4 will be described with reference to FIG. 1. The transfer unit 4 includes a transfer drum 41 and a pressurizing drum 42. Each of these drums is a rotating body that rotates about a rotation axis in the Y direction and has a columnar outer peripheral surface. In FIG. 1, arrows shown in respective views of the transfer drum 41 and the pressurizing drum 42 indicate their rotation directions. The transfer drum 41 rotates clockwise, and the pressurizing drum 42 rotates anticlockwise.

The transfer drum 41 is a support member that supports the transfer member 2 on its outer peripheral surface. The transfer member 2 is provided on the outer peripheral surface of the transfer drum 41 continuously or intermittently in a circumferential direction. If the transfer member 2 is provided continuously, it is formed into an endless swath. If the transfer member 2 is provided intermittently, it is formed into swaths with ends dividedly into a plurality of segments. The respective segments can be arranged in an arc at an equal pitch on the outer peripheral surface of the transfer drum 41.

The transfer member 2 moves cyclically on the circular orbit by rotating the transfer drum 41. By the rotational phase of the transfer drum 41, the position of the transfer member 2 can be discriminated into a processing area R1 before discharge, a discharge area R2, processing areas R3 and R4 after discharge, a transfer area R5, and a processing area R6 after transfer. The transfer member 2 passes through these areas cyclically.

The processing area R1 before discharge is an area where preprocessing is performed on the transfer member 2 before the print unit 3 discharges ink and an area where the peripheral unit 5A performs processing. In this embodiment, a reactive liquid is applied. The discharge area R2 is a formation area where the print unit 3 forms an ink image by discharging ink to the transfer member 2. The processing areas R3 and R4 after discharge are processing areas where processing is performed on the ink image after ink discharge. The processing area R3 after discharge is an area where the peripheral unit 5B performs processing, and the processing area R4 after discharge is an area where the peripheral unit 5C performs processing. The transfer area R5 is an area where the transfer unit 4 transfers the ink image on the transfer member 2 to the print medium P. The processing area R6 after transfer is an area where post processing is performed on the transfer member 2 after transfer and an area where the peripheral unit 5D performs processing.

In this embodiment, the discharge area R2 is an area with a predetermined section. The other areas R1 and R3 to R6 have narrower sections than the discharge area R2. Comparing to the face of a clock, in this embodiment, the processing area R1 before discharge is positioned at almost 10 o'clock, the discharge area R2 is in a range from almost 11 o'clock to 1 o'clock, the processing area R3 after discharge is positioned at almost 2 o'clock, and the processing area R4 after discharge is positioned at almost 4 o'clock. The transfer area R5 is positioned at almost 6 o'clock, and the processing area R6 after transfer is an area at almost 8 o'clock.

The transfer member 2 may be formed by a single layer but may be an accumulative body of a plurality of layers. If the transfer member 2 is formed by the plurality of layers, it may include three layers of, for example, a surface layer, an elastic layer, and a compressed layer. The surface layer is an outermost layer having an image formation surface where the ink image is formed. By providing the compressed layer, the compressed layer absorbs deformation and disperses a local pressure fluctuation, making it possible to maintain transferability even at the time of high-speed printing. The elastic layer is a layer between the surface layer and the compressed layer.

As a material for the surface layer, various materials such as a resin and a ceramic can be used appropriately. In respect of durability or the like, however, a material high in compressive modulus can be used. More specifically, an acrylic resin, an acrylic silicone resin, a fluoride-containing resin, a condensate obtained by condensing a hydrolyzable organosilicon compound, and the like can be given. The surface layer that has undergone a surface treatment may be used in order to improve wettability of the reactive liquid, the transferability of an image, or the like. Frame processing, a corona treatment, a plasma treatment, a polishing treatment, a roughing treatment, an active energy beam irradiation treatment, an ozone treatment, a surfactant treatment, a silane coupling treatment, or the like can be given as the surface treatment. A plurality of them may be combined. It is also possible to provide any desired surface shape in the surface layer.

For example, acrylonitrile-butadiene rubber, acrylic rubber, chloroprene rubber, urethane rubber, silicone rubber, or the like can be given as a material for the compressed layer. When such a rubber material is formed, a porous rubber material may be formed by blending a predetermined amount of a vulcanizing agent, vulcanizing accelerator, or the like and further blending a foaming agent, or a filling agent such as hollow fine particles or salt as needed. Consequently, a bubble portion is compressed along with a volume change with respect to various pressure fluctuations, and thus deformation in directions other than a compression direction is small, making it possible to obtain more stable transferability and durability. As the porous rubber material, there are a material having an open cell structure in which respective pores continue to each other and a material having a closed cell structure in which the respective pores are independent of each other. However, either structure may be used, or both of these structures may be used.

As a member for the elastic layer, the various materials such as the resin and the ceramic can be used appropriately. In respect of processing characteristics, various materials of an elastomer material and a rubber material can be used. More specifically, for example, fluorosilicone rubber, phenyl silicone rubber, fluorine rubber, chloroprene rubber, urethane rubber, nitrile rubber, and the like can be given. In addition, ethylene propylene rubber, natural rubber, styrene rubber, isoprene rubber, butadiene rubber, the copolymer of ethylene/propylene/butadiene, nitrile-butadiene rubber, and the like can be given. In particular, silicone rubber, fluorosilicone rubber, and phenyl silicon rubber are advantageous in terms of dimensional stability and durability because of their small compression set. They are also advantageous in terms of transferability because of their small elasticity change by a temperature.

Between the surface layer and the elastic layer and between the elastic layer and the compressed layer, various adhesives or double-sided adhesive tapes can also be used in order to fix them to each other. The transfer member 2 may also include a reinforce layer high in compressive modulus in order to suppress elongation in a horizontal direction or maintain resilience when attached to the transfer drum 41. Woven fabric may be used as a reinforce layer. The transfer member 2 can be manufactured by combining the respective layers formed by the materials described above in any desired manner.

The outer peripheral surface of the pressurizing drum 42 is pressed against the transfer member 2. At least one grip mechanism which grips the leading edge portion of the print medium P is provided on the outer peripheral surface of the pressurizing drum 42. A plurality of grip mechanisms may be provided separately in the circumferential direction of the pressurizing drum 42. The ink image on the transfer member 2 is transferred to the print medium P when it passes through a nip portion between the pressurizing drum 42 and the transfer member 2 while being conveyed in tight contact with the outer peripheral surface of the pressurizing drum 42.

The transfer drum 41 and the pressurizing drum 42 share a driving source such as a motor that drives them. A driving force can be delivered by a transmission mechanism such as a gear mechanism.

<Peripheral Unit>

The peripheral units 5A to 5D are arranged around the transfer drum 41. In this embodiment, the peripheral units 5A to 5D are specifically an application unit, an absorption unit, a heating unit, and a cleaning unit in order.

The application unit 5A is a mechanism which applies the reactive liquid onto the transfer member 2 before the print unit 3 discharges ink. The reactive liquid is a liquid that contains a component increasing an ink viscosity. An increase in ink viscosity here means that a coloring material, a resin, and the like that form the ink react chemically or suck physically by contacting the component that increases the ink viscosity, recognizing the increase in ink viscosity. This increase in ink viscosity includes not only a case in which an increase in viscosity of entire ink is recognized but also a case in which a local increase in viscosity is generated by coagulating some of components such as the coloring material and the resin that form the ink.

The component that increases the ink viscosity can use, without particular limitation, a substance such as metal ions or a polymeric coagulant that causes a pH change in ink and coagulates the coloring material in the ink, and can use an organic acid. For example, a roller, a printhead, a die coating apparatus (die coater), a blade coating apparatus (blade coater), or the like can be given as a mechanism which applies the reactive liquid. If the reactive liquid is applied to the transfer member 2 before the ink is discharged to the transfer member 2, it is possible to immediately fix ink that reaches the transfer member 2. This makes it possible to suppress bleeding caused by mixing adjacent inks.

The absorption unit 5B is a mechanism which absorbs a liquid component from the ink image on the transfer member 2 before transfer. It is possible to suppress, for example, a blur of an image printed on the print medium P by decreasing the liquid component of the ink image. Describing a decrease in liquid component from another point of view, it is also possible to represent it as condensing ink that forms the ink image on the transfer member 2. Condensing the ink means increasing the content of a solid content such as a coloring material or a resin included in the ink with respect to the liquid component by decreasing the liquid component included in the ink.

The absorption unit 5B includes, for example, a liquid absorbing member that decreases the amount of the liquid component of the ink image by contacting the ink image. The liquid absorbing member may be formed on the outer peripheral surface of the roller or may be formed into an endless sheet-like shape and run cyclically. In terms of protection of the ink image, the liquid absorbing member may be moved in synchronism with the transfer member 2 by making the moving speed of the liquid absorbing member equal to the peripheral speed of the transfer member 2.

The liquid absorbing member may include a porous body that contacts the ink image. The pore size of the porous body on the surface that contacts the ink image may be equal to or smaller than 10 μm in order to suppress adherence of an ink solid content to the liquid absorbing member. The pore size here refers to an average diameter and can be measured by a known means such as a mercury intrusion technique, a nitrogen adsorption method, an SEM image observation, or the like. Note that the liquid component does not have a fixed shape, and is not particularly limited if it has fluidity and an almost constant volume. For example, water, an organic solvent, or the like contained in the ink or reactive liquid can be given as the liquid component.

The heating unit 5C is a mechanism which heats the ink image on the transfer member 2 before transfer. A resin in the ink image melts by heating the ink image, improving transferability to the print medium P. A heating temperature can be equal to or higher than the minimum film forming temperature (MFT) of the resin. The MFT can be measured by each apparatus that complies with a generally known method such as JIS K 6828-2: 2003 or ISO 2115: 1996. From the viewpoint of transferability and image robustness, the ink image may be heated at a temperature higher than the MFT by 10° C. or higher, or may further be heated at a temperature higher than the MFT by 20° C. or higher. The heating unit 5C can use a known heating device, for example, various lamps such as infrared rays, a warm air fan, or the like. An infrared heater can be used in terms of heating efficiency.

The cleaning unit 5D is a mechanism which cleans the transfer member 2 after transfer. The cleaning unit 5D removes ink remaining on the transfer member 2, dust on the transfer member 2, or the like. The cleaning unit 5D can use a known method, for example, a method of bringing a porous member into contact with the transfer member 2, a method of scraping the surface of the transfer member 2 with a brush, a method of scratching the surface of the transfer member 2 with a blade, or the like as needed. A known shape such as a roller shape or a web shape can be used for a cleaning member used for cleaning.

As described above, in this embodiment, the application unit 5A, the absorption unit 5B, the heating unit 5C, and the cleaning unit 5D are included as the peripheral units. However, cooling functions of the transfer member 2 may be applied, or cooling units may be added to these units. In this embodiment, the temperature of the transfer member 2 may be increased by heat of the heating unit 5C. If the ink image exceeds the boiling point of water as a prime solvent of ink after the print unit 3 discharges ink to the transfer member 2, performance of liquid component absorption by the absorption unit 5B may be degraded. It is possible to maintain the performance of liquid component absorption by cooling the transfer member 2 such that the temperature of the discharged ink is maintained below the boiling point of water.

The cooling unit may be an air blowing mechanism which blows air to the transfer member 2, or a mechanism which brings a member (for example, a roller) into contact with the transfer member 2 and cools this member by air-cooling or water-cooling. The cooling unit may be a mechanism which cools the cleaning member of the cleaning unit 5D. A cooling timing may be a period before application of the reactive liquid after transfer.

<Supply Unit>

The supply unit 6 is a mechanism which supplies ink to each printhead 30 of the print unit 3. The supply unit 6 may be provided on the rear side of the printing system 1. The supply unit 6 includes a reservoir TK that reserves ink for each kind of ink. Each reservoir TK may be made of a main tank and a sub tank. Each reservoir TK and a corresponding one of the printheads 30 communicate with each other by a liquid passageway 6a, and ink is supplied from the reservoir TK to the printhead 30. The liquid passageway 6a may circulate ink between the reservoirs TK and the printheads 30. The supply unit 6 may include, for example, a pump that circulates ink. A deaerating mechanism which deaerates bubbles in ink may be provided in the middle of the liquid passageway 6a or in each reservoir TK. A valve that adjusts the fluid pressure of ink and an atmospheric pressure may be provided in the middle of the liquid passageway 6a or in each reservoir TK. The heights of each reservoir TK and each printhead 30 in the Z direction may be designed such that the liquid surface of ink in the reservoir TK is positioned lower than the ink discharge surface of the printhead 30.

<Conveyance Apparatus>

The conveyance apparatus 1B is an apparatus that feeds the print medium P to the transfer unit 4 and discharges, from the transfer unit 4, the printed product P′ to which the ink image was transferred. The conveyance apparatus 1B includes a feeding unit 7, a plurality of conveyance drums 8 and 8a, two sprockets 8b, a chain 8c, and a collection unit 8d. In FIG. 1, an arrow inside a view of each constituent element in the conveyance apparatus 1B indicates a rotation direction of the constituent element, and an arrow outside the view of each constituent element indicates a conveyance path of the print medium P or the printed product P′. The print medium P is conveyed from the feeding unit 7 to the transfer unit 4, and the printed product P′ is conveyed from the transfer unit 4 to the collection unit 8d. The side of the feeding unit 7 may be referred to as an upstream side in a conveyance direction, and the side of the collection unit 8d may be referred to as a downstream side.

The feeding unit 7 includes a stacking unit where the plurality of print media P are stacked and a feeding mechanism which feeds the print media P one by one from the stacking unit to the most upstream conveyance drum 8. Each of the conveyance drums 8 and 8a is a rotating body that rotates about the rotation axis in the Y direction and has a columnar outer peripheral surface. At least one grip mechanism which grips the leading edge portion of the print medium P (printed product P′) is provided on the outer peripheral surface of each of the conveyance drums 8 and 8a. A gripping operation and release operation of each grip mechanism may be controlled such that the print medium P is transferred between the adjacent conveyance drums.

The two conveyance drums 8a are used to reverse the print medium P. When the print medium P undergoes double-side printing, it is not transferred to the conveyance drum 8 adjacent on the downstream side but transferred to the conveyance drums 8a from the pressurizing drum 42 after transfer onto the surface. The print medium P is reversed via the two conveyance drums 8a and transferred to the pressurizing drum 42 again via the conveyance drums 8 on the upstream side of the pressurizing drum 42. Consequently, the reverse surface of the print medium P faces the transfer drum 41, transferring the ink image to the reverse surface.

The chain 8c is wound between the two sprockets 8b. One of the two sprockets 8b is a driving sprocket, and the other is a driven sprocket. The chain 8c runs cyclically by rotating the driving sprocket. The chain 8c includes a plurality of grip mechanisms spaced apart from each other in its longitudinal direction. Each grip mechanism grips the end of the printed product P′. The printed product P′ is transferred from the conveyance drum 8 positioned at a downstream end to each grip mechanism of the chain 8c, and the printed product P′ gripped by the grip mechanism is conveyed to the collection unit 8d by running the chain 8c, releasing gripping. Consequently, the printed product P′ is stacked in the collection unit 8d.

<Post Processing Unit>

The conveyance apparatus 1B includes post processing units 10A and 10B. The post processing units 10A and 10B are mechanisms which are arranged on the downstream side of the transfer unit 4, and perform post processing on the printed product P′. The post processing unit 10A performs processing on the obverse surface of the printed product P′, and the post processing unit 10B performs processing on the reverse surface of the printed product P′. The contents of the post processing includes, for example, coating that aims at protection, glossy, and the like of an image on the image printed surface of the printed product P′. For example, liquid application, sheet welding, lamination, and the like can be given as an example of coating.

<Inspection Unit>

The conveyance apparatus 1B includes inspection units 9A and 9B. The inspection units 9A and 9B are mechanisms which are arranged on the downstream side of the transfer unit 4, and inspect the printed product P′.

In this embodiment, the inspection unit 9A is an image capturing apparatus that captures an image printed on the printed product P′ and includes an image sensor, for example, a CCD sensor, a CMOS sensor, or the like. The inspection unit 9A captures a printed image while a printing operation is performed continuously. Based on the image captured by the inspection unit 9A, it is possible to confirm a temporal change in tint or the like of the printed image and determine whether to correct image data or print data. In this embodiment, the inspection unit 9A has an imaging range set on the outer peripheral surface of the pressurizing drum 42 and is arranged to be able to partially capture the printed image immediately after transfer. The inspection unit 9A may inspect all printed images or may inspect the images every predetermined sheets.

In this embodiment, the inspection unit 9B is also an image capturing apparatus that captures an image printed on the printed product P′ and includes an image sensor, for example, a CCD sensor, a CMOS sensor, or the like. The inspection unit 9B captures a printed image in a test printing operation. The inspection unit 9B can capture the entire printed image. Based on the image captured by the inspection unit 9B, it is possible to perform basic settings for various correction operations regarding print data. In this embodiment, the inspection unit 9B is arranged at a position to capture the printed product P′ conveyed by the chain 8c. When the inspection unit 9B captures the printed image, it captures the entire image by temporarily suspending the run of the chain 8c. The inspection unit 9B may be a scanner that scans the printed product P′.

<Control Unit>

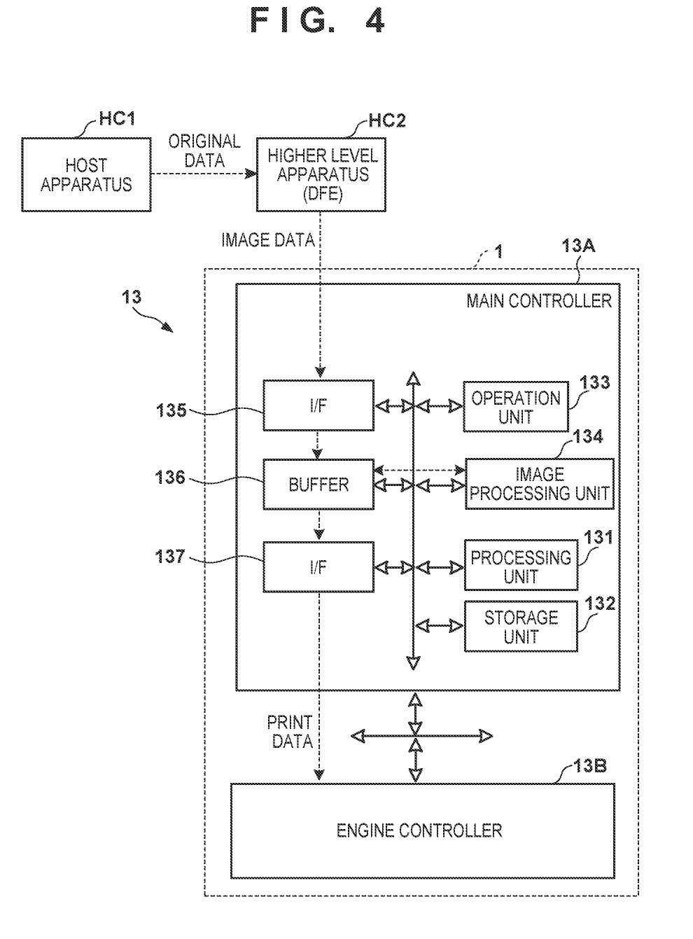

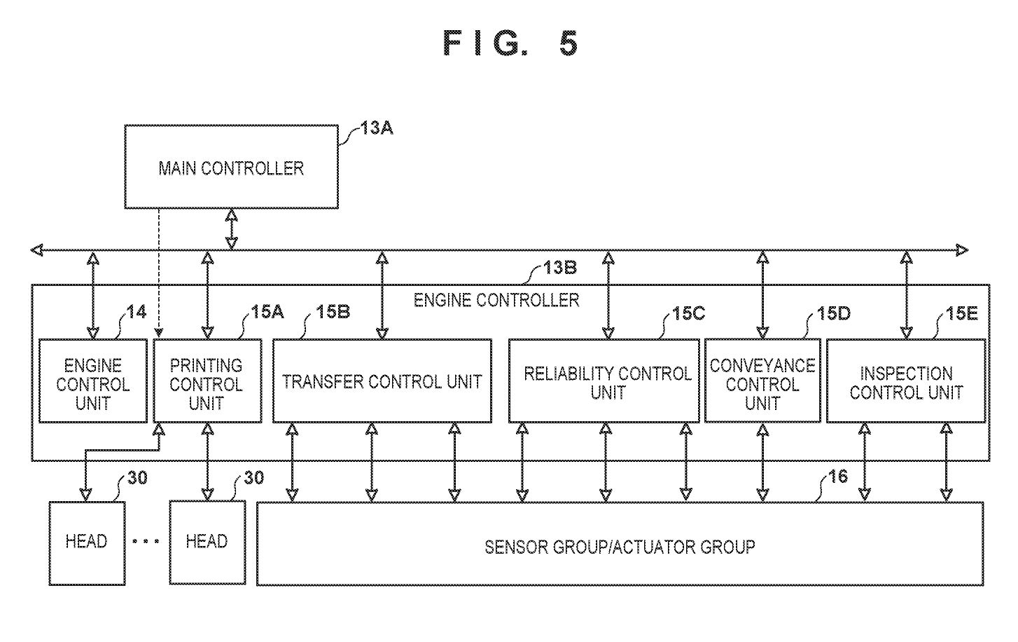

A control unit of the printing system 1 will be described next. FIGS. 4 and 5 are block diagrams each showing a control unit 13 of the printing system 1. The control unit 13 is communicably connected to a higher level apparatus (DFE) HC2, and the higher level apparatus HC2 is communicably connected to a host apparatus HC1.

Original data to be the source of a printed image is generated or saved in the host apparatus HC1. The original data here is generated in the format of, for example, an electronic file such as a document file or an image file. This original data is transmitted to the higher level apparatus HC2. In the higher level apparatus HC2, the received original data is converted into a data format (for example, RGB data that represents an image by RGB) available by the control unit 13. The converted data is transmitted from the higher level apparatus HC2 to the control unit 13 as image data. The control unit 13 starts a printing operation based on the received image data.

In this embodiment, the control unit 13 is roughly divided into a main controller 13A and an engine controller 13B. The main controller 13A includes a processing unit 131, a storage unit 132, an operation unit 133, an image processing unit 134, a communication I/F (interface) 135, a buffer 136, and a communication I/F 137.

The processing unit 131 is a processor such as a CPU, executes programs stored in the storage unit 132, and controls the entire main controller 13A. The storage unit 132 is a storage device such as a RAM, a ROM, a hard disk, or an SSD, stores data and the programs executed by the processing unit (CPU) 131, and provides the processing unit (CPU) 131 with a work area. An external storage unit may further be provided in addition to the storage unit 132. The operation unit 133 is, for example, an input device such as a touch panel, a keyboard, or a mouse and accepts a user instruction. The operation unit 133 may be formed by an input unit and a display unit integrated with each other. Note that a user operation is not limited to an input via the operation unit 133, and an arrangement may be possible in which, for example, an instruction is accepted from the host apparatus HC1 or the higher level apparatus HC2.

The image processing unit 134 is, for example, an electronic circuit including an image processing processor. The buffer 136 is, for example, a RAM, a hard disk, or an SSD. The communication I/F 135 communicates with the higher level apparatus HC2, and the communication I/F 137 communicates with the engine controller 13B. In FIG. 4, broken-line arrows exemplify the processing sequence of image data. Image data received from the higher level apparatus HC2 via the communication I/F 135 is accumulated in the buffer 136. The image processing unit 134 reads out the image data from the buffer 136, performs predetermined image processing on the readout image data, and stores the processed data in the buffer 136 again. The image data after the image processing stored in the buffer 136 is transmitted from the communication I/F 137 to the engine controller 13B as print data used by a print engine.

As shown in FIG. 5, the engine controller 13B includes an engine control units 14 and 15A to 15E, and obtains a detection result of a sensor group/actuator group 16 of the printing system 1 and controls driving of the groups. Each of these control units includes a processor such as a CPU, a storage device such as a RAM or a ROM, and an interface with an external device. Note that the division of the control units is merely illustrative, and a plurality of subdivided control units may perform some of control operations or conversely, the plurality of control units may be integrated with each other, and one control unit may be configured to implement their control contents.

The engine control unit 14 controls the entire engine controller 13B. The printing control unit 15A converts print data received from the main controller 13A into raster data or the like in a data format suitable for driving of the printheads 30. The printing control unit 15A controls discharge of each printhead 30.

The transfer control unit 15B controls the application unit 5A, the absorption unit 5B, the heating unit 5C, and the cleaning unit 5D.

The reliability control unit 15C controls the supply unit 6, the recovery unit 12, and a driving mechanism which moves the print unit 3 between the discharge position POS1 and the recovery position POS3.

The conveyance control unit 15D controls driving of the transfer unit 4 and controls the conveyance apparatus 1B. The inspection control unit 15E controls the inspection unit 9B and the inspection unit 9A.

Of the sensor group/actuator group 16, the sensor group includes a sensor that detects the position and speed of a movable part, a sensor that detects a temperature, an image sensor, and the like. The actuator group includes a motor, an electromagnetic solenoid, an electromagnetic valve, and the like.

### Operation Example

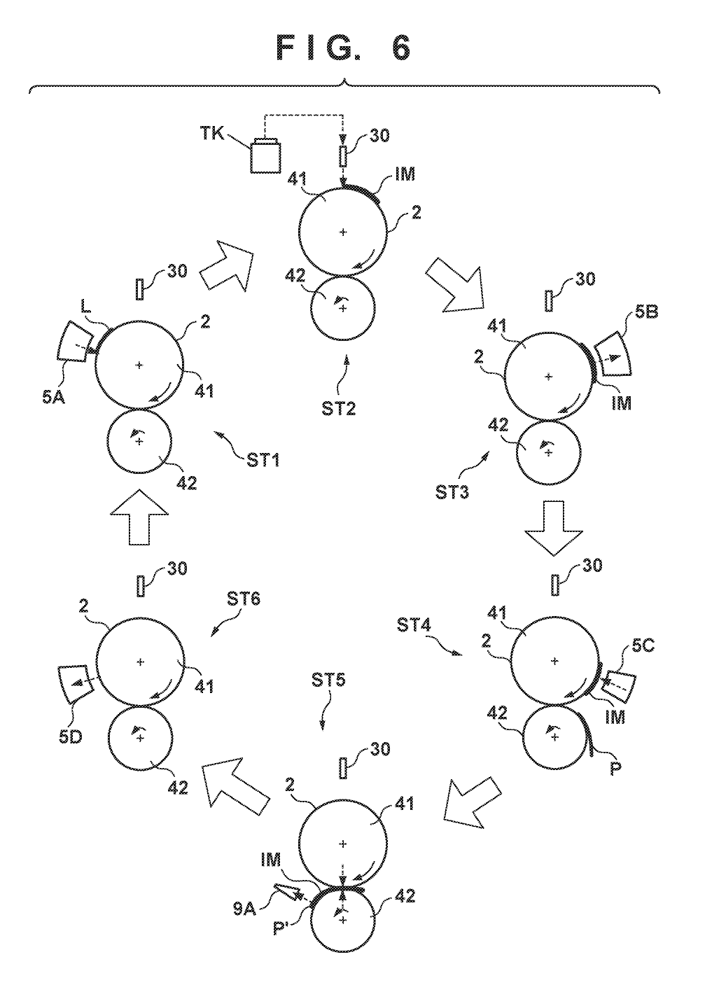

FIG. 6 is a view schematically showing an example of a printing operation. Respective steps below are performed cyclically while rotating the transfer drum 41 and the pressurizing drum 42. As shown in a state ST1, first, a reactive liquid L is applied from the application unit 5A onto the transfer member 2. A portion to which the reactive liquid L on the transfer member 2 is applied moves along with the rotation of the transfer drum 41. When the portion to which the reactive liquid L is applied reaches under the printhead 30, ink is discharged from the printhead 30 to the transfer member 2 as shown in a state ST2. Consequently, an ink image IM is formed. At this time, the discharged ink mixes with the reactive liquid L on the transfer member 2, promoting coagulation of the coloring materials. The discharged ink is supplied from the reservoir TK of the supply unit 6 to the printhead 30.

The ink image IM on the transfer member 2 moves along with the rotation of the transfer member 2. When the ink image IM reaches the absorption unit 5B, as shown in a state ST3, the absorption unit 5B absorbs a liquid component from the ink image IM. When the ink image IM reaches the heating unit 5C, as shown in a state ST4, the heating unit 5C heats the ink image IM, a resin in the ink image IM melts, and a film of the ink image IM is formed. In synchronism with such formation of the ink image IM, the conveyance apparatus 1B conveys the print medium P.

As shown in a state ST5, the ink image IM and the print medium P reach the nip portion between the transfer member 2 and the pressurizing drum 42, the ink image IM is transferred to the print medium P, and the printed product P′ is formed. Passing through the nip portion, the inspection unit 9A captures an image printed on the printed product P′ and inspects the printed image. The conveyance apparatus 1B conveys the printed product P′ to the collection unit 8d.

When a portion where the ink image IM on the transfer member 2 is formed reaches the cleaning unit 5D, it is cleaned by the cleaning unit 5D as shown in a state ST6. After the cleaning, the transfer member 2 rotates once, and transfer of the ink image to the print medium P is performed repeatedly in the same procedure. The description above has been given such that transfer of the ink image IM to one print medium P is performed once in one rotation of the transfer member 2 for the sake of easy understanding. It is possible, however, to continuously perform transfer of the ink image IM to the plurality of print media P in one rotation of the transfer member 2.

Each printhead 30 needs maintenance if such a printing operation continues.

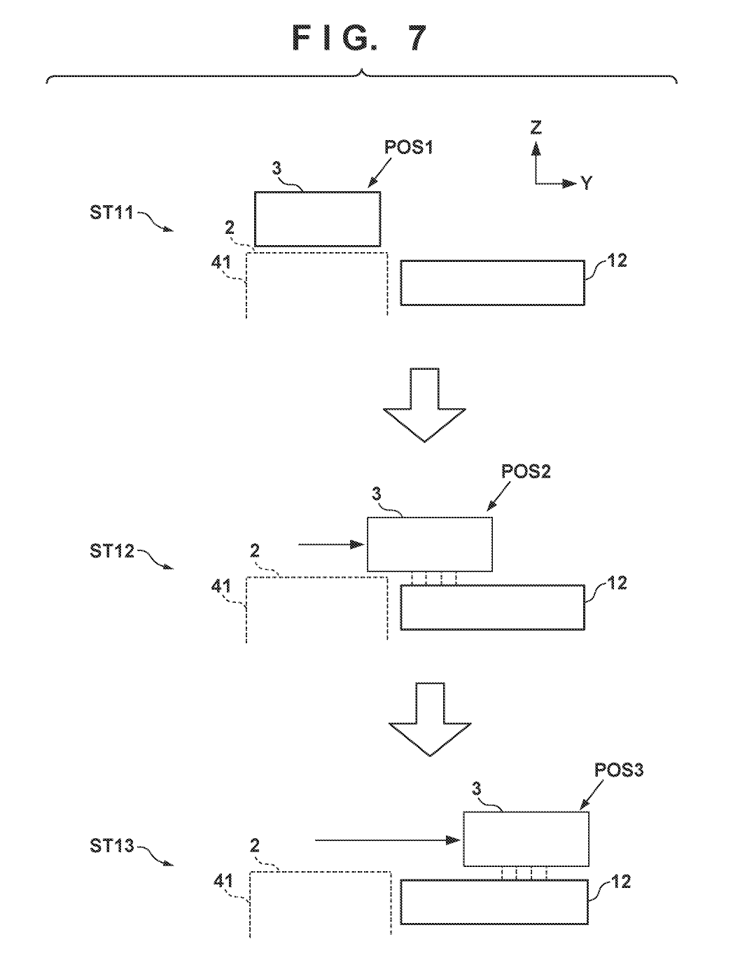

FIG. 7 shows an operation example at the time of maintenance of each printhead 30. A state ST11 shows a state in which the print unit 3 is positioned at the discharge position POS1. A state ST12 shows a state in which the print unit 3 passes through the preliminary recovery position POS2. Under passage, the recovery unit 12 performs a process of recovering discharge performance of each printhead 30 of the print unit 3. Subsequently, as shown in a state ST13, the recovery unit 12 performs the process of recovering the discharge performance of each printhead 30 in a state in which the print unit 3 is positioned at the recovery position POS3.

An absorption process of absorbing a liquid component from an image formed on the transfer member 2 performed by the absorption unit 5B in the printing system having the above arrangement will be described next.

<Absorption Unit>

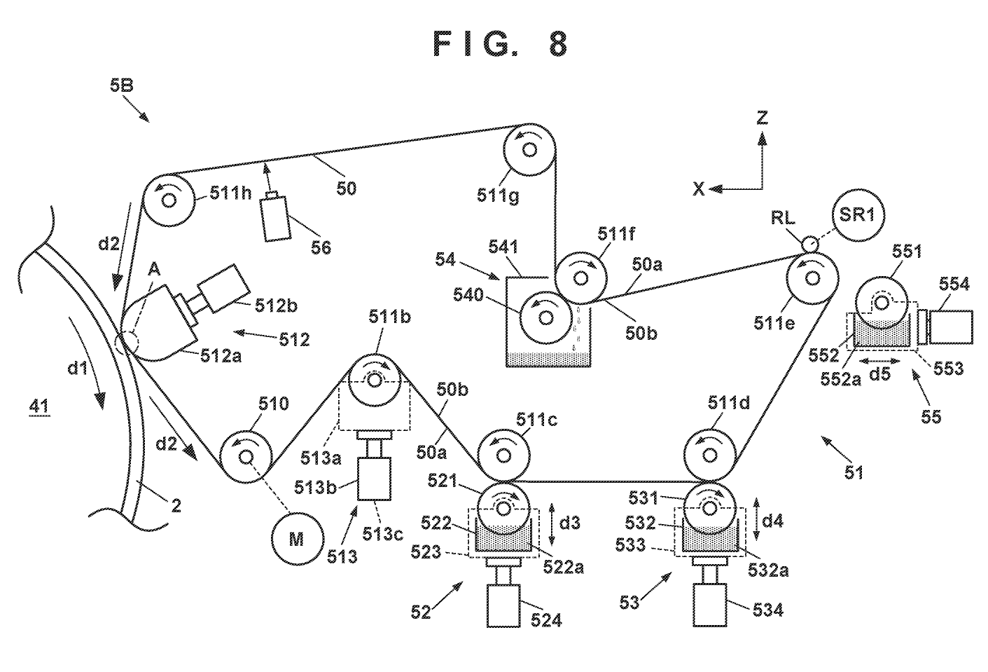

A detailed example of the absorption unit 5B will be described with reference to FIG. 8. FIG. 8 is a schematic view showing an example of the absorption unit 5B. The absorption unit 5B is a liquid absorbing apparatus that absorbs a liquid component from the ink image IM formed on the transfer member 2 before the ink image IM is transferred to the print medium P. In a case where the water-soluble pigment ink is used as in this embodiment, the absorption unit 5B mainly aims at absorbing moisture in the ink image. This makes it possible to suppress occurrence of curling or cockling of the print medium P.

The absorption unit 5B includes a liquid absorbing member 50, a driving unit 51 that cyclically moves the liquid absorbing member 50, a displacing unit 512, a plurality of kinds of recovery units 52 to 54, a preprocessing unit 55, and a detection unit 56.

The liquid absorbing member 50 is an absorber that absorbs the liquid component from the ink image IM and is a liquid absorbing sheet formed into an endless belt in the example of FIG. 8. A liquid absorbing position A is a position where the liquid absorbing member 50 absorbs the liquid component from the ink image IM on the transfer member 2 and indicates a portion where the liquid absorbing member 50 gets closest to the transfer member 2. An arrow d1 indicates a moving direction of the transfer member 2, and an arrow d2 indicates a moving direction of the liquid absorbing member 50.

The liquid absorbing member 50 may be formed by a single layer but may be formed by multiple layers. A double layer structure of an obverse layer and a reverse layer is exemplified here. The obverse layer forms a first surface 50a contacting the ink image IM, and the reverse layer forms a second surface 50b on an opposite side. The liquid absorbing member 50 absorbs the liquid component of the ink image IM on the transfer member 2. The liquid component of the ink image IM penetrates from the obverse layer into the liquid absorbing member 50 and further penetrates into the reverse layer. The ink image IM moves toward the heating unit 5C with a decreased liquid component.

Each of the obverse layer and the reverse layer can be made of a porous material. The average pore size of the reverse layer can be made larger than that of the obverse layer in order to increase absorption performance of the liquid component while suppressing adherence of the coloring material. This makes it possible to promote movement of the liquid component from the obverse layer to the reverse layer.

A material for the obverse layer may be, for example, a hydrophilic material whose contact angle with respect to water is less than 90° or a water-repellent material whose contact angle with respect to water is 90° or more. For the hydrophilic material, the material may have the contact angle with respect to water to be 40° or less. The contact angle may be measured complying with a technique described in, for example, “6. static method” of JIS R3257.

The hydrophilic material has an effect of drawing up a liquid by a capillary force. Cellulose, polyacrylamide, or a composite material of these can be given as the hydrophilic material. In a case where the water-repellent material is used, a hydrophilic treatment may be performed on its surface. A method such as sputter etching can be given as the hydrophilic treatment.

For example, a fluorine resin can be given as the water-repellent material. For example, polytetrafluoroethylene, polychlorotrifluoroethylene, polyvinylidene fluoride, or the like can be given as the fluorine resin. A time may be taken until the effect of drawing up the liquid is exerted in a case where the water-repellent material is used for the obverse layer. To cope with this, a liquid whose contact angle with the obverse layer is less than 90° may be impregnated into the obverse layer.

For example, resin-fiber nonwoven fabric or woven fabric can be given as a material for the reverse layer. The material for the reverse layer may have the contact angle of water equal to or larger than that for the obverse layer because the liquid component does not flow backward from the reverse layer to the obverse layer. For example, polyolefin, polyurethane, polyamide such as nylon, polyester, polysulfone, or a composite material of these can be given as the material for the reverse layer.

For example, adhesive lamination, thermal lamination, or the like can be given as a laminating method of the obverse layer and the reverse layer.

The driving unit 51 is a mechanism which supports the liquid absorbing member 50 such that it can rotate and move cyclically so as to pass through the liquid absorbing position A, and includes a drive rotating body 510 and a plurality of driven rotating bodies 511b to 511h. The drive rotating body 510 and the driven rotating bodies 511 are rollers or pulleys around which the swath liquid absorbing member 50 is wound and are supported rotatably about an axis in the Y direction.

The drive rotating body 510 is a conveyance rotating body such as a conveyance roller that rotates by a driving force of a motor M, and rotates and drives the liquid absorbing member 50. The driven rotating bodies 511b to 511h are supported freely rotatably. In this embodiment, these drive rotating body 510 and driven rotating bodies 511b to 511h define a rotating and moving path of the liquid absorbing member 50. The rotating and moving path of the liquid absorbing member 50 is a zigzag path winding up and down when viewed from a rotating and moving direction (arrow d2). This makes it possible to use the longer liquid absorbing member 50 in a smaller space and decrease a replacement frequency upon performance deterioration in the liquid absorbing member 50.

The driven rotating body 511b includes a tension adjustment mechanism 513. The tension adjustment mechanism 513 is a mechanism which adjusts the tension of the liquid absorbing member 50 and includes a support member 513a, a moving mechanism 513b, and a sensor 513c. The support member 513a supports the driven rotating body 511b rotatably about the axis in the Y direction. The moving mechanism 513b is a mechanism which moves the support member 513a and is, for example, an electrically-driven cylinder. The moving mechanism 513b can displace the position of the driven rotating body 511b, adjusting the tension of the liquid absorbing member 50. The sensor 513c detects the tension of the liquid absorbing member 50. In this embodiment, the sensor 513c detects a load received by the moving mechanism 513b. The tension of the liquid absorbing member 50 can be controlled automatically by controlling the moving mechanism 513b based on a detection result of the sensor 513c.

The displacing unit 512 is a mechanism which displaces the liquid absorbing member 50 between a contact state in which the liquid absorbing member 50 contacts the transfer member 2 and a retracted state in which the liquid absorbing member 50 is separated from the transfer member 2. In this embodiment, the displacing unit 512 acts on a part of the liquid absorbing member 50, and displaces the liquid absorbing member 50 between a state in which the part contacts the transfer member and a state in which the part is separated from the transfer member. However, the displacing unit 512 may move the liquid absorbing member 50 as a unit.

The displacing unit 512 includes a movable member 512a and a pressing mechanism 512b. The movable member 512a is arranged facing the transfer member 2 and has a peripheral surface where the liquid absorbing member 50 slidably moves. The pressing mechanism 512b is a mechanism which moves the movable member 512a forward/backward with respect to the transfer member 2, and is, for example, an electrically-driven cylinder. The part of the liquid absorbing member is pressed against the transfer member 2 via the movable member 512a by driving the pressing mechanism 512b.

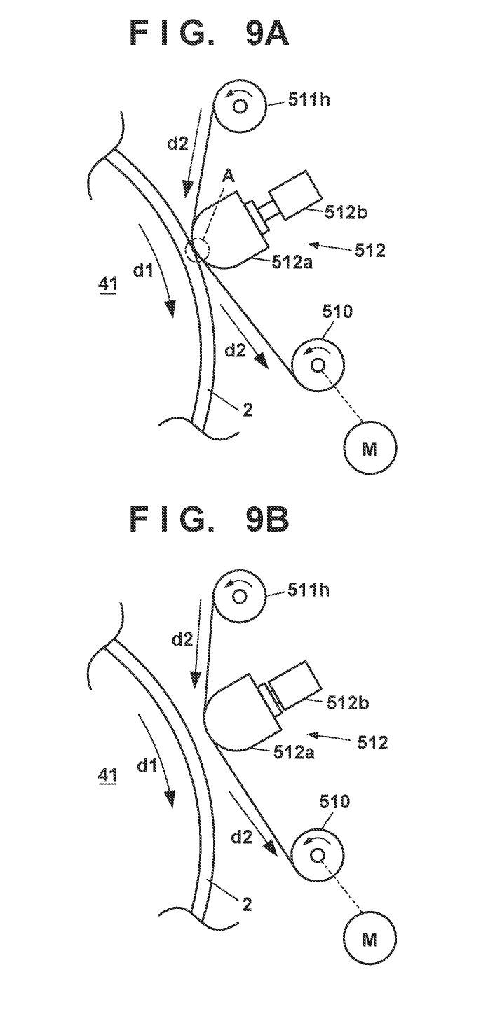

FIGS. 9A and 9B are explanatory views showing the operation of the displacing unit 512. FIG. 9A shows a state in which the liquid absorbing member 50 is displaced to the contact state. FIG. 9B shows a state in which the liquid absorbing member 50 is displaced to the retracted state.

When the liquid absorbing member 50 is displaced to the contact state, the liquid absorbing member 50 and the transfer member 2 contact each other at the liquid absorbing position A. At the liquid absorbing position A, the liquid absorbing member 50 is nipped by the transfer member 2 and the movable member 512a. The liquid absorbing member 50 is advantageously pressed against the transfer member 2 in terms of liquid absorption efficiency. During a printing operation, the driving unit 51 controls the liquid absorbing member 50 so that a rotating and moving velocity of the liquid absorbing member 50 becomes equal to a peripheral velocity of the transfer member 2. This prevents friction between the liquid absorbing member 50 and the transfer member 2 or the ink image IM.

The retracted state can be at a position where the liquid absorbing member 50 can be separated from the transfer member 2, and a distance between the contact state and the retracted state can be short. A direction in which the part of the liquid absorbing member 50 moves between the contact state and the retracted state, that is, the pressing/releasing direction of the pressing mechanism 512b is a direction crossing the tangential direction of the transfer member 2 at the liquid absorbing position A and is, for example, a perpendicular direction.

The liquid absorbing member 50 is arranged to contact or separate from the transfer member 2 freely by providing the displacing unit 512, making it easier to perform a maintenance operation or warm-up of the transfer member 2 and liquid absorbing member 50 individually.

Referring back to FIG. 8, a sensor SR1 detects a rotating and moving velocity or rotating and moving amount of the liquid absorbing member 50. The sensor SR1 is, for example, a rotary encoder. In this embodiment, a rotating body RL of the sensor SR1 contacts the liquid absorbing member 50, rotates in accordance with rotation and movement of the liquid absorbing member 50, and detects its rotation amount. The rotating body RL is arranged facing the driven rotating body 511e. The rotating and moving velocity or rotating and moving amount of the liquid absorbing member 50 can also be specified by detecting and calculating the rotation velocity of the drive rotating body 510 or those of the driven rotating bodies 511b to 511h. However, the liquid absorbing member 50 may slip with respect to these rotating bodies, and thus a value different from an actual moving velocity of the liquid absorbing member 50 may be obtained.

The cleaning unit 52, the application unit 53, and the collection unit 54 are apparatuses that recover the liquid absorption performance of the liquid absorbing member 50. By providing such recovery mechanisms, it is possible to suppress the performance deterioration in the liquid absorbing member 50 and maintain the liquid absorption performance for a longer time. This makes it possible to decrease the replacement frequency of the liquid absorbing member 50.

In this embodiment, the three kinds of recovery units 52 to 54 different in function are arranged in the middle of the moving path of the liquid absorbing member 50. However, only one recovery unit may be provided. Alternatively, a plurality of recovery units having a common function may be provided.

The cleaning unit 52 and the application unit 53 perform processes on the first surface 50a, and the collection unit 54 performs a process on the second surface 50b. By performing the different processes for the first surface 50a and the second surface 50b, it is possible to recover the liquid absorption performance of the liquid absorbing member 50 more properly.

The cleaning unit 52 is an apparatus that cleans the liquid absorbing member 50. The cleaning unit 52 includes a cleaning roller 521, a reservoir 522, a support member 523, and a moving mechanism 524. The support member 523 supports the cleaning roller 521 rotatably about the axis in the Y direction and also supports the reservoir 522. A cleaning liquid 522a is reserved in the reservoir 522. The cleaning roller 521 is partially immersed in the cleaning liquid 522a. The moving mechanism 524 is a mechanism which moves the support member 523 and is, for example, an electrically-driven cylinder. The cleaning roller 521 and the reservoir 522 also move when the support member 523 moves. They move in the direction of an arrow d3 (here, the vertical direction) between a cleaning position at which the cleaning roller 521 contacts the liquid absorbing member 50 and a retracted position at which the cleaning roller 521 is separated from the liquid absorbing member 50. FIG. 8 shows a state in which the cleaning roller 521 is located at the cleaning position (a state during a recovery operation). The cleaning roller 521 may be located at the cleaning position during the operation of the printing system 1 and may move to the retracted position at the time of maintenance.

The cleaning roller 521 is arranged facing the driven rotating body 511c. The liquid absorbing member 50 is arranged to be nipped by the cleaning roller 521 and the driven rotating body 511c when the cleaning roller 521 moves to the cleaning position. The cleaning roller 521 rotates in accordance with rotation and movement of the liquid absorbing member 50. The peripheral surface of the cleaning roller 521 is formed by, for example, a cohesive material and removes a dust particle (paper dust or the like) adhered to the first surface 50a of the liquid absorbing member 50 by contacting the first surface 50a. For example, rubber of butyl, silicone, urethan, or the like can be given as a material for the peripheral surface of the cleaning roller 521. The cleaning liquid 522a is, for example, a surfactant and can use a liquid that promotes separation of a dust particle adhered to the cleaning roller 521. The reservoir 522 may include a wiper that promotes separation of a dust particle by contacting the surface of the cleaning roller 521. A roller which is higher in adhesiveness than the cleaning roller 521 and takes out the dust particle from the cleaning roller 521 may be arranged in the reservoir 522.

In this embodiment, an arrangement that removes the dust particle adhered to the first surface 50a of the liquid absorbing member 50 by the cleaning roller 521 is adopted. However, another arrangement such as an arrangement that removes the dust particle by blowing air may also be adopted.

The application unit 53 is an apparatus that applies a moisturizing liquid to the liquid absorbing member 50. The application unit 53 includes an application roller 531, a reservoir 532, a support member 533, and a moving mechanism 534. The support member 533 supports the application roller 531 rotatably about the axis in the Y direction and also supports the reservoir 532. A moisturizing liquid 532a is reserved in the reservoir 532. The application roller 531 is partially immersed in the moisturizing liquid 532a. The moving mechanism 534 is a mechanism which moves the support member 533 and is, for example, an electrically-driven cylinder. The application roller 531 and the reservoir 532 also move when the support member 533 moves. They move in the direction of an arrow d4 (here, the vertical direction) between an application position at which the application roller 531 contacts the liquid absorbing member 50 and a retracted position at which the application roller 531 is separated from the liquid absorbing member 50. FIG. 8 shows a state in which the application roller 531 is located at the application position (a state during the recovery operation). The application roller 531 may be located at the application position during the operation of the printing system 1 and may move to the retracted position at the time of maintenance.

The application roller 531 is arranged facing the driven rotating body 511d. The liquid absorbing member 50 is arranged to be nipped by the application roller 531 and the driven rotating body 511d when the application roller 531 moves to the application position. The application roller 531 rotates in accordance with rotation and movement of the liquid absorbing member 50. The peripheral surface of the application roller 531 is formed by, for example, rubber and supplies the moisturizing liquid 532a reserved in the reservoir 532 to the first surface 50a of the liquid absorbing member 50 by drawing the moisturizing liquid 532a. The moisturizing liquid 532a is, for example, water. The moisturizing liquid 532a may contain a water-soluble organic solvent or a surfactant.

The first surface 50a may be thickened by using the liquid absorbing member 50, and this may degrade absorption performance of the liquid component from the ink image IM. It is possible to suppress thickening of the first surface 50a and maintain the absorption performance of the liquid component by applying the moisturizing liquid 532a to the first surface 50a.

In this embodiment, an arrangement that draws the moisturizing liquid 532a to the first surface 50a of the liquid absorbing member 50 by the application roller 531 is adopted. However, another arrangement such as an arrangement that sprays the moisturizing liquid 532a to the first surface 50a by a nozzle may also be adopted.

The collection unit 54 is an apparatus that removes the liquid component from the liquid absorbing member 50. The collection unit 54 includes a removing roller 540 and a reservoir 541 that stores the removed liquid component.

The removing roller 540 is arranged facing the driven rotating body 511f. The liquid absorbing member 50 is arranged to be nipped by the removing roller 540 and the driven rotating body 511f when the removing roller 540 moves to a removal position. The removing roller 540 rotates in accordance with rotation and movement of the liquid absorbing member 50. The liquid absorbing member 50 is sandwiched between the removing roller 540 and the driven rotating body 511f, squeezing out the liquid component absorbed by the liquid absorbing member 50. In that sense, the driven rotating body 511f commonly uses a part of the collection unit 54.

In the collection unit 54, the second surface 50b of the liquid absorbing member 50 is located on the lower side in a gravity direction, and the first surface 50a is located on the upper side in the gravity direction. Therefore, it is more likely that the liquid component is squeezed out of the side of the second surface 50b than of the side of the first surface 50a and falls due to gravity. It is possible to ensure a region for absorbing the liquid component in the reverse layer and recover the liquid absorption performance of the liquid absorbing member 50 by promoting removal of the liquid component from the second surface 50b. It is also possible to suppress drying of the first surface 50a to which the moisturizing liquid is applied by the application unit 53.

As described above, in this embodiment, an arrangement is adopted in which the cleaning unit 52, the application unit 53, and the collection unit 54 perform recovery processing in the processing order of the removal of the dust particle, moisturizing, and the removal of the liquid component from an upstream side to a downstream side in the rotating and moving direction of the liquid absorbing member 50. The processing order is not limited to this. According to the processing order of this embodiment, however, the application unit 53 moisturizes the first surface 50a after the cleaning unit 52 cleans the first surface 50a, making it possible to promote the removal of the dust particle and an improvement in moisture retention. Moreover, the collection unit 54 removes the liquid component relatively on the downstream side, making it possible to remove the liquid component in a place where the second surface 50b moves at a high position in the gravity direction. This has the advantage that the removed liquid component is easily collected by using gravity.

The preprocessing unit 55 will be described next. The preprocessing unit 55 is an apparatus that mainly performs preprocessing for making full use of the liquid absorption performance of the liquid absorbing member 50 in a short time at the start of the operation of the printing system 1 or the like. In this embodiment, a preprocessing liquid is applied to the first surface 50a of the liquid absorbing member 50, improving a rise in liquid absorption performance. For example, in a case where an obverse layer 501 is made of the water-repellent material, the preprocessing liquid can use a surfactant. F-444 (trade name, available from DIC) or ZonylFS3100 (trade name, available from DuPont) of a fluorochemical surfactant is given as the surfactant. Furthermore, CapstoneFS-3100 (trade name, available from The Chemours CompanyLCC), BYK349 (trade name, available from BYK) of a silicone-based surfactant, or the like is also given.

The preprocessing unit 55 includes an application roller 551, a reservoir 552, a support member 553, and a moving mechanism 554. The support member 553 supports the application roller 551 rotatably about the axis in the Y direction and also supports the reservoir 552. A preprocessing liquid 552a is reserved in the reservoir 552. The application roller 551 is partially immersed in the preprocessing liquid 552a. The moving mechanism 554 is a mechanism which moves the support member 553 and is, for example, an electrically-driven cylinder. The application roller 551 and the reservoir 552 also move when the support member 553 moves. They move in the direction of an arrow d5 (here, the horizontal direction) between an application position at which the application roller 551 contacts the liquid absorbing member 50 and a retracted position at which the application roller 551 is separated from the liquid absorbing member 50. FIG. 8 shows a state in which the application roller 551 is located at the retracted position. The application roller 551 can move to the application position at the start of the operation of the printing system 1 or periodically (for example, in the unit of the number of print media P to be processed).

The application roller 551 is arranged facing the driven rotating body 511e. The liquid absorbing member 50 is arranged to be nipped by the application roller 551 and the driven rotating body 511e when the application roller 551 moves to the application position. The application roller 551 rotates in accordance with rotation and movement of the liquid absorbing member 50. The peripheral surface of the application roller 551 is formed by, for example, rubber and supplies the preprocessing liquid 552a reserved in the reservoir 552 to the first surface 50a of the liquid absorbing member 50 by drawing the preprocessing liquid 552a.

With this arrangement, the absorption unit 5B absorbs the liquid component from the ink image IM on the transfer member 2 by the liquid absorbing member 50. The liquid component can be absorbed from the ink image IM continuously by absorbing the liquid component simultaneously with cyclical rotation and movement of the liquid absorbing member 50. In addition, the liquid absorption performance of the liquid absorbing member 50 can be maintained for a longer period of time by providing the cleaning unit 52, the application unit 53, and the collection unit 54, making it possible to prolong a replacement cycle of the liquid absorbing member 50.

The detection unit 56 is a sensor that detects passage of a predetermined portion of the liquid absorbing member 50 at a predetermined position on the moving path of the liquid absorbing member 50. In this embodiment, the detection unit 56 is arranged at a position comparatively near the liquid absorbing position A. In one round of the moving path of the liquid absorbing member 50 with the liquid absorbing position A as a starting point and an ending point, the position of the detection unit 56 can be a position on a side closer to the ending point than an intermediate point or a position on a side closer to the ending point than an intermediate point between the intermediate point and the ending point.

FIG. 10 is a schematic view showing the arrangement of the collection unit 54.

As shown in FIG. 10, the removing roller 540 is arranged to be located diagonally downward (45° from the vertical direction) with respect to the driven rotating body (driven roller) 511f.

For a liquid collection operation, the liquid absorbing member 50 is bent, winding the first surface 50a of the liquid absorbing member 50 around the driven rotating body (driven roller) 511f. Note that a state without winding is defined if the liquid absorbing member 50 is located at a position indicated by a broken line in FIG. 10 in a direction perpendicular to a line segment (P-P′) that connects a center P′ of the driven roller 511f and a center P of the removing roller 540. Then, it is possible to increase a region in which the first surface 50a of the liquid absorbing member 50 contacts the driven rotating body 511f by changing a state from the state without winding to a state in which the liquid absorbing member 50 is wound on the side of the driven rotating body 511f (counterclockwise). With the arrangement in which the first surface 50a of the liquid absorbing member 50 is wound around the driven rotating body 511f, the liquid component is not transuded from the side of the first surface 50a but is transuded from the side of the second surface 50b when a collection operation is performed.

Note that as an arrangement that limits a side from which the liquid component is transuded, the present invention is not limited to winding the liquid absorbing member 50 around the roller. For example, liquid collection may be performed, in which a nonporous belt member similar to the liquid absorbing member 50 is pressed while being superimposed on the liquid absorbing member 50 before liquid collection.

Consequently, a liquid is transuded from the second surface 50b of the liquid absorbing member 50 positively, and a liquid transuded from the first surface 50a is suppressed, collecting the liquid efficiently.

The quality of members for the driven roller 511f and removing roller 540 is not particularly limited. From the viewpoint of a squeezing amount, it is desirable that the removing roller 540 that contacts the second surface 50b of the liquid absorbing member 50 is softer than the driven roller 511f that contacts the first surface 50a of the liquid absorbing member 50. Moreover, from the viewpoint of the conveyance property of the liquid absorbing member 50, surface processing may be performed, or a layer may be provided on the obverse layer in consideration of friction with the liquid absorbing member 50.

An arrangement that collects a squeezed liquid is not particularly limited. The squeezed liquid cannot go forward of a pressed region, overflows from the liquid absorbing member 50, and moves in the gravity direction. It is therefore preferable that the reservoir 541 is provided under the driven roller 511f and removing roller 540 of the collection unit 54 to collect a falling liquid with a pump or the like.

In a case where the liquid is collected by using the reservoir 541, it is desirable that the approach angle of the liquid absorbing member 50 with respect to the driven roller 511f of the collection unit 54 is horizontal, or the liquid absorbing member 50 approaches from diagonally above. It is thus possible to prevent the squeezed liquid from moving and falling freely in the gravity direction along the liquid absorbing member 50.

The positional relationship between the driven roller 511f and the removing roller 540 is not particularly limited. From the viewpoint of the projection area of the reservoir 541, however, it is desirable that their centers are aligned in the vertical direction. By doing so, the liquid is collected immediately below the two rollers, making it possible to reduce the size of the reservoir 541 in the horizontal direction.

The arrangement of the collection unit 54 has been described above with reference to FIGS. 8 and 10. However, there are several examples concerning the positional relationship between the driven roller 511f and the removing roller 540, the quality of their members, and the approach angle of the liquid absorbing member 50 and in addition, liquid collection capacities are different in accordance with the examples. Therefore, the liquid collection capacities in a case in which the positional relationship between the driven roller 511f and the removing roller 540, the quality of their members, and the approach angle of the liquid absorbing member 50 are different will be described next.

Note that in the following examples, a “part” is a mass standard unless otherwise specified.

The following conditions are used to evaluate the liquid collection capacities. More specifically,

Surface temperature of the transfer member 2:
60° C. obtained by heating with the heating unit 5C

Reactive liquid applied to the transfer member 2:
application amount is 1 g/m²

The composition of the reactive liquid is as follows:

| | |
|---|---|
| glutaric acid | 21.0 mass % |
| glycerine | 5.0 mass % |
| surfactant | 5.0 mass % |
| (F-444 (trade name, available from DIC)) | |
| ion-exchanged water | balance |

Ink applied amount by the printhead 30:
20 g/m²

The composition of ink is as follows:

| | |
|---|---|
| dispersed pigment (the content of a coloring material is | 40.0 mass % |
| 10.0 mass %) | |
| dispersed resin particle | 20.0 mass % |
| glycerine | 7.0 mass % |
| polyethylene glycol (number average molecular weight | 3.0 mass % |
| (Mn): 1,000) surfactant: | |
| Acetylenol E100 (available from Kawaken Fine | 0.5 mass % |
| Chemicals) | |
| ion-exchanged water | balance |

Note that the balance of the ion-exchanged water is an amount when the total of all components that constitute ink becomes 100.0 mass %. Then, after this was stirred and dispersed sufficiently, pressure filtration was performed in a microfilter (available from Fujifilm) having a pore size of 3.0 μm, preparing black ink.

Moreover, the composition of a dispersed fat particle and the dispersed pigment is as follows.

<Preparation of Pigment Dispersion>

A dispersion treatment was performed for 5 hrs while mixing 10 parts of carbon black (product name: MONARCH 1100, available from CABOT), 15 parts of a resin aqueous solution (obtained by neutralizing an aqueous solution containing a styrene-ethyl acrylate-acrylic acid copolymer, and having an acid number of 150, a weight-average molecular weight (Mw) of 8,000, and a resin content of 20.0 mass % with a potassium hydroxide aqueous solution), and 75 parts of pure water, charging them into a batch vertical sand mill (available from AIMEX), filling them with 200 parts of zirconia beads with 0.3 mm in diameter, and cooling them with water. After this dispersion liquid was centrifuged, and coarse particles were removed, a black dispersed pigment having a pigment content of 10.0 mass % was obtained.

<Preparation of Dispersed Resin Particle>

20 parts of ethyl methacrylate, 3 parts of 2,2′-azobis-(2-methylbutyronitrile), and 2 parts of n-hexadecane were mixed and stirred for 0.5 hrs.

This mixture was dripped to 75 parts of 8% an aqueous solution of a styrene-butyl acrylate-acrylic acid copolymer (acid number: 130 mgKOH/g, weight-average molecular weight (Mw): 7,000) and stirred for 0.5 hrs. Next, ultrasonic irradiation was performed for 3 hrs by an ultrasonic irradiator. Subsequently, a polymerization reaction was performed for 4 hrs at 80° C. in a nitrogen atmosphere, and filtration was performed after cooling to room temperature, preparing a dispersed resin particle having a resin content of 25.0 mass %.

Moving velocity of the liquid absorbing member 50:
the moving velocity was adjusted to be equal to the moving velocity of the transfer member 2 by the respective rollers 510, 511b, 511c, 511d, 511e, 511f, 511g, 511h, and 540.

Print medium P:
aurora coated paper (available from Nippon Paper Group; a grammage of 104 g/m²)

Conveyance velocity of the print medium P:
conveyance was performed by the conveyance drums 8 and 8a to be equal to the moving velocity of the transfer member 2 such that the conveyance velocity was 0.2 m/s.

### Example 1

A porous body formed by two layers of the first layer and the second layer was used as a liquid absorbing member 50 shown in FIG. 8. The first layer of the liquid absorbing member 50 is brought into contact with an image which is formed by ink discharged from a printhead 30 to a transfer member 2, making it possible to absorb a liquid content of ink and condense the image. PTFE having 0.2 μm in pore size and 10 μm in thickness obtained by rolling a resin to the first layer was used for the first layer here. Woven fabric made of a PET material having 20 μm in pore size and 190 μm in thickness was used for the second layer. Then, a body obtained by integrating these first layer and second layer with heat pressure lamination was used. In this example, a Gurley value of the liquid absorbing member 50 defined by JIS P8117 is 8 sec. An arrangement in which an application roller 551 supplied 10 g/m² of water to the liquid absorbing member 50 after liquid absorption was adopted.

Here, in a collection unit 54, by giving the liquid absorbing member 50 a winding angle to a driven roller 511f before a pressed region, a first surface 50a of the liquid absorbing member 50 was sealed before the pressed region, and the approach angle of the liquid absorbing member 50 to the driven roller 511f was made horizontal. Chief materials for the driven roller 511f and a removing roller 540 were SUS (stainless steel). A PFA layer was formed, by using a heat shrinkable tube, on the surface of the driven roller 511f that contacts the first surface 50a of the liquid absorbing member 50. A liquid was collected by installing a reservoir 541 under the driven roller 511f and the removing roller 540.

Ten thousand samples were created by performing a continuous printing operation.

### Example 2

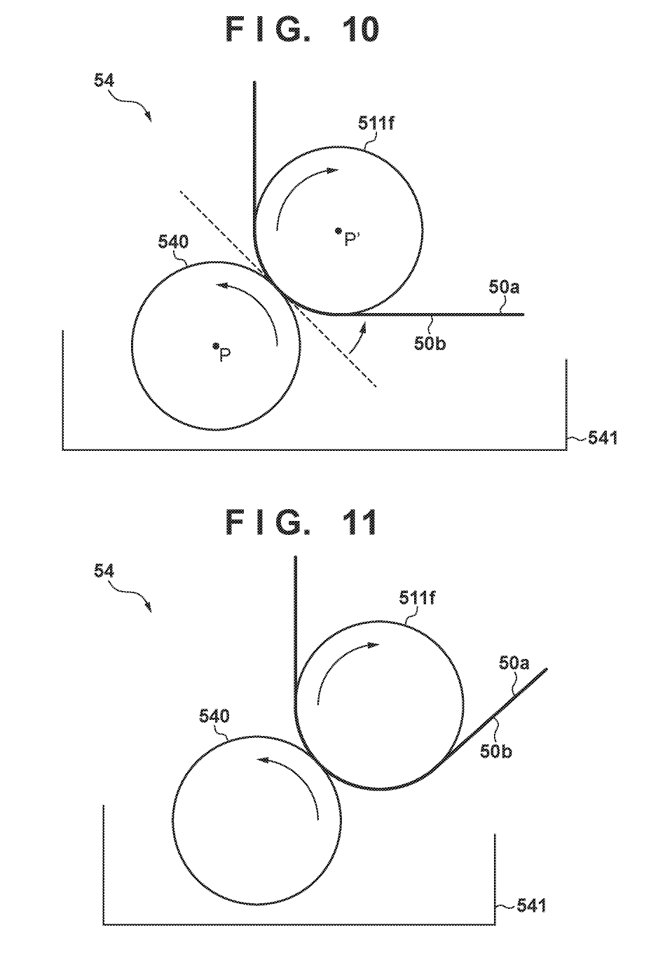

In Example 1, as shown in FIG. 11, the approach angle of the liquid absorbing member 50 to the driven roller 511f of the collection unit 54 was obtained by causing the liquid absorbing member 50 to approach the driven roller 511f from diagonally above. Samples were created as in Example 1 except for this.

### Example 3

In Example 2, a material for the driven roller 511f was EPDM rubber. Samples were created as in Example 2 except for this. In other words, the hardness of a driven roller 511f is lower than that of a removing roller 540.

### Example 4

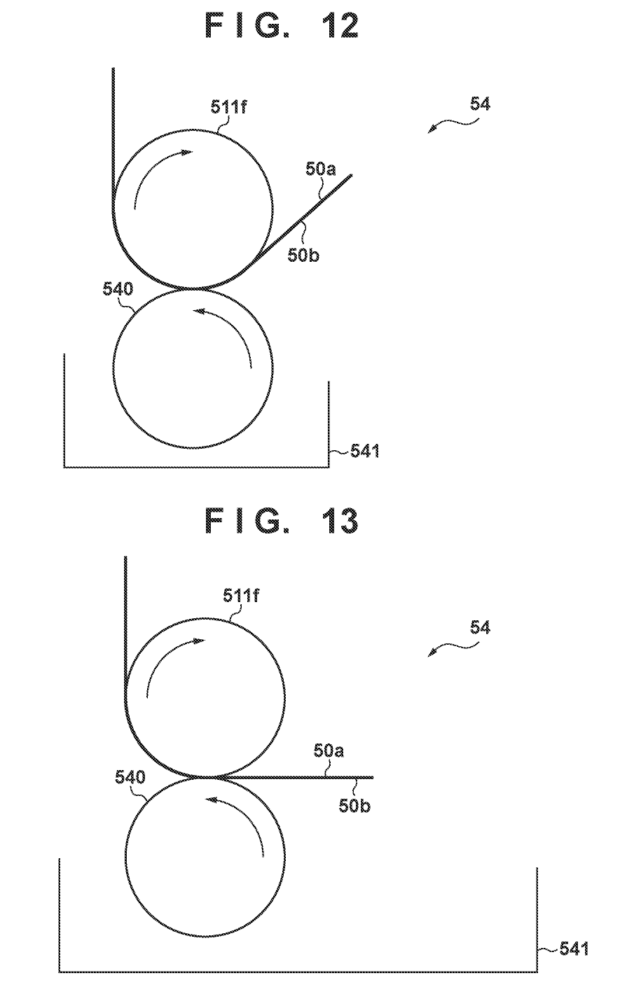

In Example 3, as shown in FIG. 12, the driven roller 511f and the removing roller 540 were arranged to have a positional relationship in which they were arranged in a vertical direction. Samples were created as in Example 3 except for this.

### Comparative Example 1

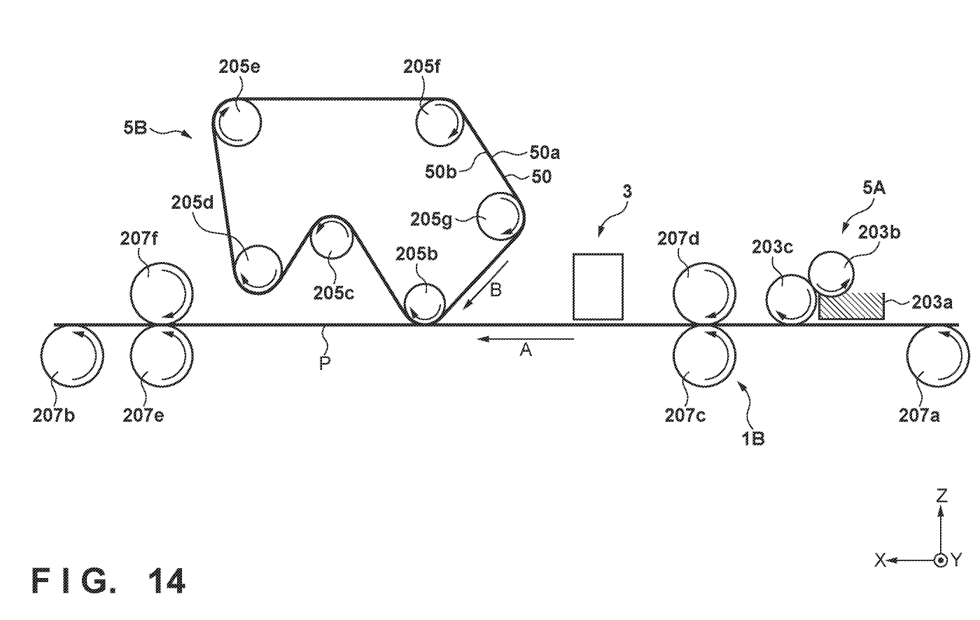

In Comparative Example 1, as shown in FIG. 13, a driven roller 511f and a removing roller 540 were arranged to have a positional relationship in which they were arranged in a vertical direction, and the approach angle of a liquid absorbing member 50 to the driven roller 511f was set horizontal. Samples were created as in Example 1 except for this. By doing so, there was no winding angle before a pressed region.

<Evaluation>

An evaluation was performed on the presence/absence of a phenomenon in which an image was swept away when samples were created.

This is considered as a state in which the liquid absorbing member 50 cannot absorb a liquid in an image completely when the flow resistance of the liquid absorbing member 50 is high, and a coloring material of the image is swept away. This phenomenon will be referred to as “image blurring” hereinafter. It is considered that this phenomenon also occurs in a case in which the viscosity of a liquid in the liquid absorbing member 50 increases, causing the flow resistance. Table 1 shows a result.

TABLE 1

| | | | | | Comparative |
|---|---|---|---|---|---|
| | Example 1 | Example 2 | Example 3 | Example 4 | Example 1 |
| <conditions> | | | | | |
| winding/sealing | present | present | present | present | absent |
| approach angle | horizontal | horizontal or | horizontal or | horizontal or | horizontal |
| | | less | less | less | |
| arrangement | 45° | 45° | 45° | vertical | vertical |
| chief materials | SUS/SUS | SUS/SUS | SUS/rubber | SUS/rubber | SUS/SUS |
| <Evaluation> | | | | | |
| image blurring | ◯ | ◯ | ◯ | ◯ | X |
| collection | ◯ | ◯ | ⊚ | ⊚ | ◯ |
| amount | | | | | |
| reservoir area | ◯ | ⊚ | ⊚ | ⊚⊚ | ◯ |

Note:
⊚ indicates very good,
◯ indicates good, and
X indicates no good.

In Example 1, image blurring was hardly seen. The liquid was almost transuded from the second surface 50b of the liquid absorbing member 50, fell immediately below the driven roller 511f and removing roller 540 of the collection unit 54, and could be collected in the medium scale reservoir 541 (see FIG. 10).

In Example 2, image blurring was hardly seen. The liquid was almost transuded from the second surface 50b of the liquid absorbing member 50, fell immediately below the driven roller 511f and removing roller 540 of the collection unit 54, and could be collected in the small scale reservoir 541 (see FIG. 11). A squeezing amount was about 15 g/m². Even after an apparatus was stopped, the liquid content held by the liquid absorbing member 50 dripped from a squeezing portion and could be collected in the reservoir 541.

In Example 3, image blurring was hardly seen. The liquid was almost transuded from the second surface 50b of the liquid absorbing member 50, fell immediately below the driven roller 511f and removing roller 540 of the collection unit 54, and could be collected in the small scale reservoir 541. A squeezing amount was about 20 g/m², and a larger squeezing amount could be obtained. If the amount of a liquid content remaining in the liquid absorbing member 50 is large, that becomes a resistance when the liquid is absorbed next. Thus, the amount of the liquid is desirably smaller.

In Example 4, image blurring was hardly seen. The liquid was almost transuded from the second surface 50b of the liquid absorbing member 50, fell immediately below the driven roller 511f and removing roller 540 of the collection unit 54, and could be collected in the extremely small scale reservoir 541 (see FIG. 12). This is because the liquid falls from a pressurizing portion along the liquid absorbing member 50 and the rollers in accordance with gravity, and thus the projection area of a collection tank can be the smallest if the driven roller 511f and the removing roller 540 are arranged in the vertical direction, and there is the collection tank immediately below them such that the projection area becomes the smallest.

In Comparative Example 1, image blurring occurred in some samples. The liquid was transuded from both a first surface 50a and a second surface 50b of the liquid absorbing member 50. The liquid transuded from the first surface 50a overflowed before the pressed region, fell from an end portion to a lower portion along the liquid absorbing member 50, or liquid splatter from a removing roller 540 occurred.

The performance of the collection unit concerning the various examples above was evaluated. However, by adjusting the positional relationship between the driven roller and the removing roller, and the approach angle of the liquid absorbing member, occurrence of image blurring is prevented, the liquid is collected efficiently, and additionally, the size of the reservoir can be reduced.

The above-described printing system 1 uses a transfer method of forming an image by discharging ink to the transfer member 2 from the printhead 30 and transferring the image to the print medium P. However, the present invention is not limited to this. The present invention is also applicable to, for example, a printing apparatus or a printing system that adopts a method of printing an image by discharging ink from a printhead directly to a print medium. In this case, an arrangement is made such that the image is printed by discharging the ink from the printhead to the print medium at a predetermined position of a conveyance path where the print medium is conveyed and concerning a conveyance direction of the print medium, an absorption unit that absorbs a liquid content from the image formed on the print medium just on a downstream side of the predetermined position is arranged.

FIG. 14 is a side view showing the arrangement of the printing apparatus that adopts the method of printing the image by discharging the ink from the printhead directly to the print medium. As compared with the printing system shown in FIG. 1, this apparatus does not include the constituent elements such as the transfer member 2, the transfer unit 4, the cleaning unit 5D, and the like. Note that in FIG. 14, the same reference numerals denote the same constituent elements described with reference to FIG. 1, and a description thereof will be omitted.

As shown in FIG. 14, in this arrangement, the print medium P is supplied by a feeding roller 207a from a feeding unit (not shown) and conveyed in a direction of an arrow A by conveyance rollers 207c, 207d, 207e, and 207f that form the conveyance apparatus 1B. Furthermore, the print medium P is discharged outside the apparatus by a discharge roller 207b. Then, the apparatus includes the application unit 5A that applies a reactive liquid to the print medium P, the print unit 3 that prints an image by discharging ink to the print medium P, and the absorption unit 5B that absorbs a liquid component from the image formed on the print medium P. The application unit 5A includes a reservoir 203a that reserves the reactive liquid, a roller 203b that draws the reactive liquid from the reservoir 203a, and a roller 203c that applies the reactive liquid to the print medium P.

Note that the absorption unit 5B includes the liquid absorbing member 50, a pressing member 205b that presses the liquid absorbing member 50 against the image on the print medium P, and tension rollers 205c, 205d, 205e, 205f, and 205g that stretch the liquid absorbing member 50, and the liquid absorbing member moves in a direction of an arrow B.

The shapes of the liquid absorbing member 50 and pressing member 205b are not particularly limited. The same shapes as of the liquid absorbing member 50 and pressing member usable by the absorption unit 5B in the printing system 1 described above can be used. Furthermore, the number of tension rollers is not limited to five illustrated in FIG. 14. The necessary number of tension rollers can be arranged in accordance with an apparatus design.

In the printhead of the print unit 3 and a portion where the liquid absorbing member 50 is brought into contact with the image on the print medium P to remove the liquid component, a support member that supports them from below may be provided.

### Other Embodiment

In the above embodiment, the print unit 3 includes the plurality of printheads 30. However, a print unit 3 may include one printhead 30. The printhead 30 may not be a full-line head but may be of a serial type that forms an ink image by discharging ink from the printhead while scanning a carriage to which the printhead 30 is mounted in a Y direction.

A conveyance mechanism of the print medium P may adopt another method such as a method of clipping and conveying the print medium P by the pair of rollers. In the method of conveying the print medium P by the pair of rollers or the like, a roll sheet may be used as the print medium P, and a printed product P′ may be formed by cutting the roll sheet after transfer.

In the above embodiment, the transfer member 2 is provided on the outer peripheral surface of the transfer drum 41. However, another method such as a method of forming a transfer member 2 into an endless swath and running it cyclically may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-131492, filed Jul. 4, 2017, which is hereby incorporated by reference herein in its entirety.

What is claimed is:

1. A printing apparatus comprising:
a transfer member configured to be moved cyclically;
a print unit configured to form an image on the transfer member by discharging ink to the transfer member;
a transfer unit configured to perform a transfer operation of transferring, to a print medium, the image formed on the transfer member; and
a liquid absorbing unit configured to absorb a liquid component from the image on the transfer member before the transfer operation,
wherein the liquid absorbing unit comprises:
an endless liquid absorbing member having a first surface that contacts the transfer member and a second surface on a side opposite to the first surface;
a moving unit configured to cyclically rotate and move the liquid absorbing member;
a first roller that contacts the first surface;
a second roller that contacts the second surface and nips the liquid absorbing member with the first roller; and
a collection unit configured to push out and collect a liquid component absorbed by the liquid absorbing member by bending and winding the liquid absorbing member around the first roller located on an upper side of the second roller at the nipped position, and moving the liquid absorbing member with the moving unit while holding the nipped state.

2. The apparatus according to claim 1, wherein the collection unit includes a reservoir configured to reserve a liquid component which is pushed out of a region in which the liquid absorbing member is pressurized by being nipped with the first roller and the second roller, and falls.

3. The apparatus according to claim 1, wherein the first roller is arranged diagonally above with respect to the second roller.

4. The apparatus according to claim 3, wherein the moving unit makes the liquid absorbing member approach the nipped position horizontally from an upstream side in a moving direction of the liquid absorbing member and move in a vertical direction after the liquid absorbing member is wound around the first roller.

5. The apparatus according to claim 3, wherein the moving unit makes the liquid absorbing member approach the nipped position and move in a vertical direction while winding the liquid absorbing member around the first roller from diagonally above on an upstream side in a moving direction of the liquid absorbing member.

6. The apparatus according to claim 1, wherein the first roller is arranged above with respect to the second roller in a vertical direction.

7. The apparatus according to claim 6, wherein the moving unit makes the liquid absorbing member approach the nipped position horizontally from an upstream side in a moving direction of the liquid absorbing member and move in a vertical direction after the liquid absorbing member is wound around the first roller.

8. The apparatus according to claim 6, wherein the moving unit makes the liquid absorbing member approach the nipped position and move in a vertical direction while winding the liquid absorbing member around the first roller from diagonally above on an upstream side in a moving direction of the liquid absorbing member.

9. The apparatus according to claim 6, wherein hardness of the first roller is lower than hardness of the second roller.

10. The apparatus according to claim 1, wherein the liquid component is pushed out of the second surface.

11. The apparatus according to claim 1, wherein the liquid absorbing member is an endless sheet, and the apparatus further comprising a support unit configured to support the sheet cyclically and movably.

12. The apparatus according to claim 1, wherein ink forming an ink image is condensed by bringing the liquid absorbing member into contact with the ink image on the transfer member and absorbing a liquid component from the ink image.

13. A printing method comprising:
forming an image by discharging ink from a printhead;
absorbing a liquid component from the image by bringing a cyclically movable liquid absorbing member into contact with the image;
nipping the liquid absorbing member by a first roller that contacts a first surface of the liquid absorbing member and a second roller that has a vertical positional relationship with respect to the first roller and contacts a second surface on a side opposite to the first surface;
forming a region in which the liquid absorbing member is pressurized by sealing the liquid absorbing member by bending and winding the liquid absorbing member around the first roller located on an upper side of the second roller at the nipped position; and
pushing out and collecting a liquid component absorbed by the liquid absorbing member by moving the liquid absorbing member while holding the nipped state.

14. The method according to claim 13, wherein the liquid absorbing member is an endless sheet,
and the method further comprising supporting the sheet cyclically and movably.

15. The method according to claim 13, further condensing ink forming an ink image by bringing the liquid absorbing member into contact with the ink image on a transfer member and absorbing a liquid component from the ink image.
